(19) United States
(12) Patent Application Publication
(10) Pub. No.: US 2012/0233030 A1
(43) Pub. Date: Sep. 13, 2012

(54) METHOD AND SYSTEM FOR SWITCHING ENERGY SERVICE

(76) Inventor: Jason Lewis, Houston, TX (US)

(21) Appl. No.: 13/046,760

(22) Filed: Mar. 13, 2011

(51) Int. Cl. G06Q 30/00

(52) U.S. Cl. 705/27.1

(57) ABSTRACT

A method and portable electronic device provide pricing information to a customer and enable switching service from a current provider to a desired provider in response to a selection by the customer on the portable electronic device. In the method, pricing information associated with the current provider and with competitor providers is gathered. Then, the portable electronic device displays the respective pricing information and each associated provider for selection by the customer. In response to the selection of the desired provider by the customer, the portable electronic device automatically deactivates service from the current provider and activates service from the desired provider.

### FIELD OF THE INVENTION

The present disclosure pertains generally to portable electronic devices. More particularly, the present disclosure pertains to systems and methods for displaying a user's current energy service rate and competitive energy service rates, and for changing energy service from a current provider to a selected competitor in response to an inputted direction by the user.

### BACKGROUND OF THE INVENTION

In certain states, electricity service has been deregulated. Due to deregulation, a retail electricity market has been created, allowing end-use customers to choose their provider from competing electricity retailers. Specifically, power customers in deregulated states can choose their electricity service provider from a variety of Retail Electricity Providers (REPs). Within an electricity market, power and energy are commoditized, with power (in Megawatts) being the metered net electrical output of a generator at any given time, and with energy being the electricity (in Megawatt Hours) that flows through a metered point for a given time.

One notable issue with deregulated electricity markets is whether customers are provided with real-time pricing based on electricity's variable wholesale price or with a price determined by another method, such as average annual costs. Needless to say, Retail Electric Providers offer a wide range of electricity rates at any given time, possible depending on a customer's location on the energy grid; demand for energy; corporate, municipal, or private status, or other factors. Further, such offered rates may fluctuate frequently. With the low transaction cost of changing electricity providers and the fungibility of energy, there may often be a monetary incentive for customers to check competitive rates and to change providers when economically advantageous. Currently, changing electricity providers may be practical only when purchasing directly from a utility or when a fixed price contract with a provider ends. However, under the evolving state of the electricity market, customers may someday have the power to change more frequently.

Under the current scheme in Texas, approximately 85% of commercial and industrial customers have changed providers at least once since 2002. Further, under deregulation at least 40% of residential customers have changed from their incumbent retail provider to a competitive provider. As the number of deregulated markets increases, improved methods of changing providers are needed.

In light of the above, it is an object of the present invention to provide a method for providing information to a customer on a portable electronic device. Further, it is an object of the present invention to provide a method for switching service from a current provider to a desired provider in response to a selection by the customer on a portable electronic device. More specifically, an object of the present invention is to provide retail energy provider pricing information to a customer on a portable electronic device for switching energy service. Yet another object of the present invention is to provide a method for switching energy provider on a portable electronic device that is easy to implement, is simple to use, and is comparatively cost effective.

### SUMMARY OF THE INVENTION

In accordance with the present invention, a method is disclosed for providing pricing information to a customer on a portable electronic device and for switching service from a current provider to a desired provider in response to a selection by the customer on the portable electronic device.

During the method, pricing information associated with the customer's current provider is gathered. In certain embodiments, this process includes receiving customer information data into the portable electronic device. For instance, the customer may enter the customer information, such as an address, an account number, or the identity of a service provider. Additionally or alternatively, the portable electronic device may read the customer information or obtain customer information such as through the identification of the customer's address through location-determining analytics, such as a global positioning service (GPS).

When a customer's address is received by the portable electronic device, it may be used to identify the customer's current provider. For example, the current provider may be identified by transmitting the customer information data (e.g., the customer's address) to a data manager via a wireless network. In response to this transmission, the data manager can determine the identity of the customer's current provider from a database of providers, and return the identity of the customer's current provider to the portable electronic device.

Further, the data manager may find current pricing information associated with the identified current provider from a database of pricing information. Further, the data manager may communicate that current pricing information to the portable electronic device via a wireless network.

In addition to the current pricing information associated with the identified current provider, the data manager may ascertain competitor providers from a database of providers. Also, the data manager may obtain competitor pricing information associated with the ascertained competitor providers from the database of pricing information. Then, the data manager may communicate the competitor providers and the competitor pricing information to the portable electronic device via a wireless network

After the identities and pricing information of the current provider and potential competitor providers are determined, they are displayed on the portable electronic device for selection by the customer. For instance, they may be displayed as selectable buttons or other interactive graphics. As a result, the customer is provided with an easy method of selecting the energy provider of his choice in view of the displayed pricing information.

In response to the selection of the desired provider by the customer, the portable electronic device automatically discontinues service from the current provider and activates service from the desired provider. This action includes transmission of a service termination request to the current provider and a service activation request to the desired provider. Also, the portable electronic device may confirm the change of service request with the customer.

In certain embodiments, an inquiry may be sent to the customer before an end of service-term, including updated pricing information from the current provider and from other competitor providers for selection by the customer. Generally, the inquiry would be sent to customers who have previously used the interactive system to select a provider.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a flow diagram of a method for providing pricing information to a customer on a portable electronic device and for switching service from a current provider to a desired provider in response to a selection by the customer on the portable electronic device, in accordance with an embodiment herein;

FIG. 2 is a diagrammatical representation of a system for performing the method illustrated in FIG. 1, including a portable electronic device;

FIG. 3 is a front view of the portable electronic device of FIG. 2; and

FIG. 4 is a front view of a display on the portable electronic device showing provider and pricing information for review by the customer in accordance with an embodiment herein.

### DETAILED DESCRIPTION

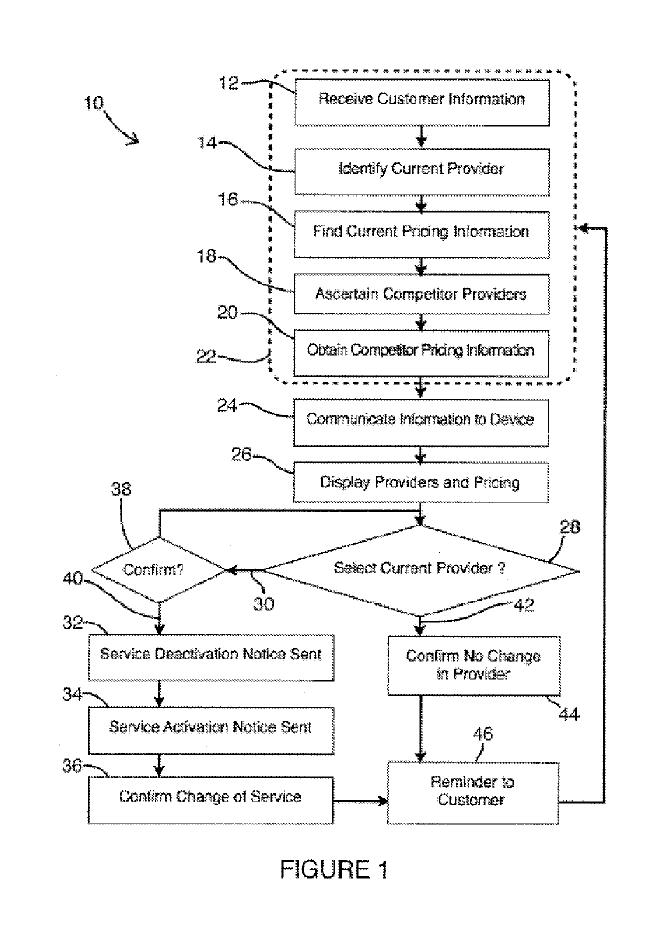

Referring initially to FIG. 1, a method for providing pricing information to a customer on a portable electronic device and for switching service is illustrated and generally designated 10. As shown in FIG. 1, the method 10 commences with the step of receiving customer information at 12. Specifically, in step 12, customer information such as the customer's name and address is entered into the portable electronic device. In this step, the customer information may be input into the electronic device though keyed or voice inputs, read by the electronic device off of an invoice, address label, or meter number, or captured through a positioning system, such as through GPS.

After the customer information is received, the current provider is identified at 14. Specifically, at 14, the portable electronic device transmits the customer information data to a data manager via a wireless network. Upon receiving the customer information, the data manager identifies the current provider from a database of providers. While the illustrated method depicts the identification of the current provider as a separate step 14, in certain embodiments, the identity of the current provider is part of the customer information received at 12. In either case, at 16 the data manager finds the current pricing information associated with the identified current provider.

In conjunction with identifying the current provider at 14 and finding the current pricing information at 16, the data manager is able to ascertain competitor providers who are able to service the customer at 18. Further, the data manager obtains pricing information associated with the ascertained competitor providers at 20. As outlined in phantom, the gathering of current and competitor provider identities and pricing information may be considered a single task 22. After the necessary information is gathered at 22, the data manager is able to communicate to the portable electronic device, at 24, the identity of the current provider, the current provider pricing information, the ascertained competitor providers, and the competitor pricing information.

In order to provide service options to the customer, the portable electronic device displays each provider and its associated pricing information for selection by the customer at 26. In certain embodiments, the portable electronic device may allow the customer to seek further information about each provider, such as business history, customer reviews, news, or other information of interest.

Upon selection of a desired provider at 28, the portable electronic device communicates the selection to the data manager. If the desired provider is selected from one of the competitor providers at 30, then a service deactivation instruction is sent to the current provider at 32 and a service activation instruction is sent to the desired provider at 34. Further, after service is switched to the desired provider, a confirmation email is sent to the customer at 36. Optionally, a confirmation request may be sent to the customer at 38 before service is switched (and before deactivation/activation instructions are sent at 32/34) to require a confirmation at 40 to change service.

If the current provider is selected as the desired provider at 42, then no further activation instructions are necessary, though a confirmation can be sent to the customer at 44.

When the service contract with the desired provider nears its expiration (e.g., sixty days before expiration) a reminder is sent to the customer at 46. As indicated by FIG. 1, the reminder includes a updated compilation of the data gathered at 22 regarding the current provider, competitor providers, and the associated pricing information for display at 26 and eventual selection at 28 by the customer.

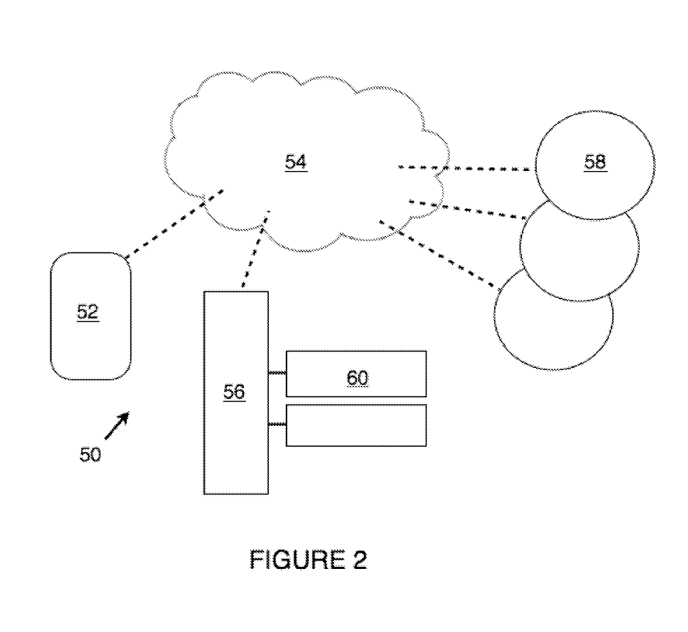

Referring now to FIG. 2, the system for performing method 10 is illustrated and generally designated 50. As shown, the system 50 includes a portable electronic device 52 in communication with a network 54. Further, the system 50 includes a server or data manager 56 also in communication with the network 54. In order to gather real time pricing information, the data manager 56 may also communicate through the network 54 with provider systems 58. Through communication with provider systems 58, the data manager 56 can create and maintain databases 60 of provider and pricing information.

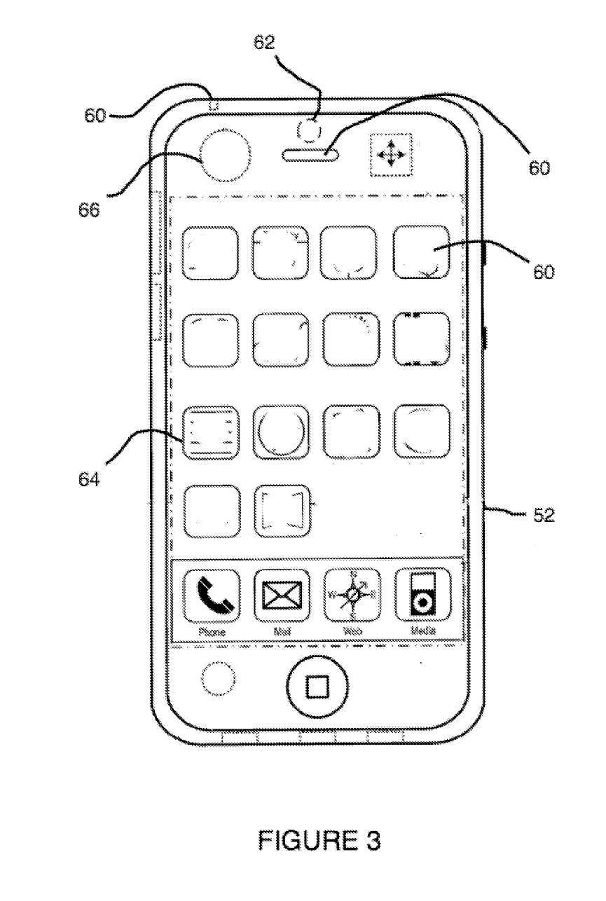

In FIG. 3, the portable electronic device 52 is shown to include a data input 60 configured to receive customer information data. Specifically, the data input 60 may comprise a keyboard for entering data, a receiver for obtaining voice data, an imaging system for reading data, and/or a positioning device for locating an address that is part of the data. Further, the device 52 includes a wireless networking interface 62 configured to communicate with the data manager 56 through the network 54 (see FIG. 2).

During operation of the method 10, the device 60 displays a selection input 64, shown as a button, configured to receive the customer's selection of the desired provider. Also, the device 60 includes a processor 66 configured to communicate data with the network 54, to operate the display of pricing to the customer, and to transmit the selection input to send a discontinuation order to the current provider and an activation order to the desired provider.

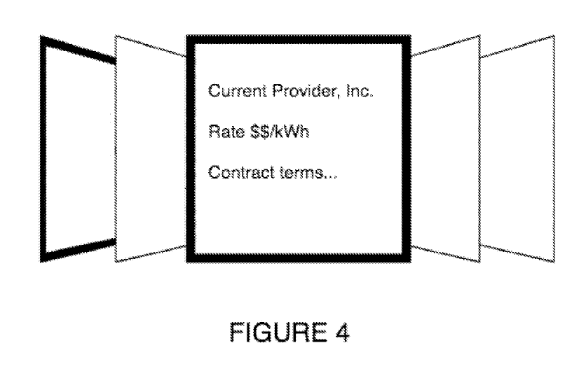

Referring now to FIG. 4, an exemplary display for showing provider and pricing information is shown. As illustrated, a customer can toggle between providers to review relevant information and pricing before selecting the desired provide.

While the particular Method and System for Switching Energy Service as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A method for providing pricing information to a customer on a portable electronic device and for switching service from a current provider to a desired provider in response to a selection by the customer on the portable electronic device, the method comprising:
gathering pricing information associated with the current provider and with competitor providers;
displaying each respective pricing information and each associated provider on the portable electronic device for selection by the customer; and
in response to the selection of the desired provider by the customer, automatically discontinuing service from the current provider and activating service from the desired provider.

2. A method as recited in claim 1 wherein the gathering action includes receiving customer information data into the portable electronic device.

3. A method as recited in claim 2 wherein the portable electronic device reads the customer information data during receiving.

4. A method as recited in claim 3 wherein the portable electronic device locates an address at which the customer is located during receiving, and wherein the customer information data includes the address.

5. A method as recited in claim 2 wherein the gathering action includes identifying the current provider from the customer information data.

6. A method as recited in claim 5 wherein the current provider is identified by transmitting the customer information data to a data manager via a wireless network, wherein, in response, the data manager returns an identity of the current provider from a database of providers.

7. A method as recited in claim 5 wherein the gathering action includes finding current pricing information associated with the identified current provider.

8. A method as recited in claim 7 wherein the current pricing information is communicated to the portable electronic device by a data manager via a wireless network after the data manager finds the current pricing information in a database of pricing information.

9. A method as recited in claim 1 wherein the gathering action includes ascertaining competitor providers.

10. A method as recited in claim 9 wherein competitor providers are ascertained by a data manager from a database of providers and communicated to the portable electronic device via a wireless network.

11. A method as recited in claim 9 wherein the gathering action includes obtaining competitor pricing information associated with the ascertained competitor providers.

12. A method as recited in claim 11 wherein the competitor pricing information is communicated to the portable electronic device by a data manager via a wireless network after the data manager obtains the competitor pricing information in a database of pricing information.

13. A method as recited in claim 1 further comprising confirming change of service with the customer.

14. A method as recited in claim 1 further comprising sending an inquiry to the customer before an end of service-term including updated pricing information from the desired provider and from other competitor providers for selection by the customer.

15. A method for providing retail energy provider pricing information to a customer on a portable electronic device and for switching energy service from a current retail energy provider to a desired retail energy provider in response to a selection by the customer on the portable electronic device, the method comprising:
receiving customer information data into the portable electronic device;
identifying the current retail energy provider from the customer identification data;
finding current pricing information associated with the identified current retail energy provider;
obtaining competitor pricing information associated with competitor retail energy providers;
displaying each respective pricing information and each associated retail energy provider on the portable electronic device for selection by the customer; and
in response to the selection of the desired retail energy provider by the customer, automatically discontinuing service from the current retail energy provider and activating service from the desired retail energy provider.

16. A method as recited in claim 15 wherein the portable electronic device reads the customer information data during receiving.

17. A method as recited in claim 15 wherein the portable electronic device locates an address at which the customer is located during receiving, and wherein the address is the customer information data.

18. A portable electronic device for providing pricing information to a customer and for switching service from a current provider to a desired provider in response to a selection by the customer, the device comprising:
a data input configured to receive customer identification data;
a wireless networking interface configured to transmit a request for pricing information associated with the current provider and with competitor providers to a data manager via a network and receive the pricing information from the data manager via the network;
a selection input configured to receive the customer's selection of the desired provider; and
a processor configured to acquire the customer identification data from the data input, to send the request to the wireless networking interface for transmission to the data manager, to display the pricing information received from the data manager in association with the selection input; and to communicate a deactivation order to the current provider and an activation order to the desired provider.

19. A portable electronic device as recited in claim 18 wherein the data input includes a positioning system to locate an address at which the customer is located, and wherein the customer information data includes the address.

20. A portable electronic device as recited in claim 18 wherein the data input includes an imaging system to read the customer identification data.
